(19) United States
(12) Patent Application Publication
(10) Pub. No.: US 2021/0123466 A1
(43) Pub. Date: Apr. 29, 2021

(54) A CONNECTION DEVICE AND A BOX ARRANGEMENT PROVIDED WITH SUCH CONNECTION DEVICE

(71) Applicant: MUNTERS EUROPE AKTIEBOLAG, Kista (SE)

(72) Inventor: Ola Sylvan, Trangsund (SE)

(21) Appl. No.: 17/252,147

(22) PCT Filed: May 27, 2019
(86) PCT No.: PCT/SE2019/050487

§ 371 Date: Dec. 14, 2020

(30) Foreign Application Priority Data
Jun. 18, 2018 (SE) 1850739-2

(51) Int. Cl. F16B 7/04; B65D 90/08; B65D 90/00

(52) U.S. Cl. CPC F16B 7/0473; B65D 90/0026; B65D 90/08

(57) ABSTRACT

A connection device (3) for a box-arrangement, the connection device (3) comprising: a first connection part (4) adapted to be connected to a first beam (1) comprising a first flange (6) and a second connection part (5) adapted to be connected to a second beam (2) comprising a second flange (7), wherein the second beam (2) is configured to extend in a direction generally perpendicular to the first beam (1) when being connected thereto by means of the connection device (3) and is configured to be connected at a first one of its ends to a first side of the first beam (1), and wherein said first and second flanges (6, 7) are configured to extend in parallel alignment with each other on a first side (8) of the first and second flanges (6, 7) when the second beam (2) is connected to the first beam (1) by means of the connection device (3), and the connection device (3) is adapted for connecting said first end of the second beam (2) to the first side of the first beam (1). The first connection part (4) comprises a third flange (10) which is configured to extend in parallel alignment with the first flange (6) of the first beam (1) on said first side (8) of the first flange (6) and to bear on the first flange (6) when the first connection part (4) is connected to the first beam (1) and which third flange (10) comprises a recess (11) configured for receiving the second flange (7) of the second beam (2) when the second beam (2) is connected to the first beam (1) by means of the connection device (3), the second connection part (5) is adapted to be connected to the first end of the second beam (2), and the first connection part (4) and the second connection part (5) of the connection device (3) comprise a device for engagement with each other.

### TECHNICAL FIELD

The present invention relates to a connection device for a box-arrangement, the connection device comprising:
a first connection part adapted to be connected to a first beam comprising a first flange (6) and
a second connection part adapted to be connected to a second beam comprising a second flange, wherein the second beam is configured to extend in a direction generally perpendicular to the first beam when being connected thereto by means of the connection device and is configured to be connected at a first one of its ends to a first side of the first beam, and wherein said first and second flanges are configured to extend in parallel alignment with each other on a first side of the first and second flanges when the second beam is connected to the first beam by means of the connection device, and
the connection device is adapted for connecting said first end of the second beam to the first side of the first beam.

The invention also comprises a box arrangement provided with first and second beams that are connected by such a connection device.

### BACKGROUND

Box arrangements in which a plurality of beams are interconnected such that they form a box framework are well known in prior art. Some of the beams are connected end to end in corner regions of the box and some of the beams are connected with their end to a longitudinal side of another beam, such that one or more openings aimed for the housing of a window or a wall element is formed in the box framework.

The beams may consist of hollow beam profiles provided with flanges that form support surfaces for the windows or wall elements or form sealing surfaces against which the windows or wall elements may bear in a sealing way. A reliable sealing connection between beams and between windows and beams or between wall elements and beams is of particular interest in box arrangements in which a predetermined pressure difference compared to outside of the box arrangement is to be provided. This is, for instance, the case in box arrangements in which a de-humidifier is arranged inside the box arrangement and a certain differential pressure is to be generated and maintained inside the box arrangement.

Different designs of coupling devices have been suggested by prior art for the purpose of connecting an end of a beam to a longitudinal side of another beam such that flanges of the beams form a surface against which windows and wall elements may bear in sealing way. Such solutions may also comprise coupling devices that enable a rapid connection of the beams to each other. According to such designs, the flange of a first beam is arranged to bear tightly on the flange of another beam, such that there is sealing also between the flanges of interconnected beams. However, due to production tolerances of the beams and flanges, and the fact that such beams and flanges are often made of metals that are not easily deformed in order to provide sealing engagement with each other, there may be leakage between the flanges of interconnected beams.

It is an object of the present invention to present a connection device for a box arrangement that provides for efficient and reliable connection of an end of a beam to a longitudinal side of another beam and that provides for good sealing between the flanges of such beams.

### SUMMARY OF THE INVENTION

The object of the invention is achieved by means of the initially defined connection device, which is characterised in that the first connection part comprises a third flange which is configured to extend in parallel alignment with the first flange of the first beam on said first side of the first flange and to bear on the first flange when the first connection part is connected to the first beam and which third flange comprises a recess configured for receiving the second flange of the second beam when the second beam is connected to the first beam by means of the connection device, wherein the second connection part is adapted to be connected to the first end of the second beam, and the first connection part and the second connection part of the connection device comprise a device for engagement with each other.

When the first beam has been attached to the second beam by means of the connection device, the first, second and third flanges will together form an unbroken chain of sealing flange surfaces to provide a complete rim surface all around the beam structure, which lets panels and doors be conveniently fitted to the frame structure in an air tight manner without having to put excessive tolerance requirements on the parts.

According to one embodiment, said device for engagement of the first connection part with the second connection part comprise a snap device for snap engagement.

According to one embodiment the snap device comprises a resilient member that carries a first engagement means and is arranged on one of the said first part or second part of the connection device, and a receiving member arranged on the other of the first part and the second part of the connection device, wherein the receiving member carries a second engagement means for engagement with said first engagement means.

According to one embodiment, said first engagement means comprises a first abutment member and that said second engagement means comprises a second abutment member. At least one of the first and second abutment member comprises a heel. According to one embodiment, the first abutment member is a heel and the second abutment member is a heel. According to one embodiment, the first abutment member is the inner periphery of a hole defined in the first connection part and the second abutment member is a heel arranged on the second connection part.

According to one embodiment, the first connection part and the second connection part comprise guide surfaces for guiding the first part and second part into snapping engagement through the snap device through a displacement of the second part in a direction perpendicular to the longitudinal directions of the first beam and the second beam, wherein the first connection part is connected to the first beam and the second connection part is connected to the second beam during said displacement.

According to one embodiment, said recess has a depth corresponding to the thickness of the second flange. Thereby, the second flange can be tightly fitted into the recess and the third flange can be in planar alignment with the first and second flanges on said first side of the first and second flanges. Thereby a window or a wall element may be sealingly arranged against the first, second and third flanges on said first side of the first and second flanges.

According to one embodiment, the recess extends from a first free end of the third flange towards a second end of the third flange, which second end is adapted to bear on an end part of the first flange when the first connection part is connected to the first beam, and the recess ends at a predetermined distance from said second end of the third flange. Longitudinal tolerance faults of the first and second flanges will thus be less critical, since there may be a play between the end of the second flange and the end of the recess closest to said second end of the third flange. According to one embodiment, the third flange configured to overlap the first flange on the side thereof opposite to the first side of the first flange. Thereby, a good sealing between the first and second flanges can be obtained also when there are tolerance faults on the latter. The third flange may also be made of a softer material than the first and second flange, such that it may be deformed and thereby forming a sealing body between the first and second flange.

According to one embodiment, the first part of the connection device has a fourth flange that extends perpendicularly to the third flange, which fourth flange is configured to bear on said first side of the first beam and which fourth flange is configured to be connected to the first beam. The fourth flange may carry the first abutment member. The third flange and the fourth flange form a single unit. Thus, the third flange and the fourth flange are integrated in the first part.

The object of the invention is also achieved by means of a box arrangement comprising: a first beam comprising a first flange and a second beam comprising a second flange, wherein the first beam is connected to the second beam by means of a connection device as defined hereinabove or hereinafter, and wherein the second beam extends in a direction generally perpendicular to the first beam when being connected thereto by means of the connection device and is connected at a first one of its ends to a first side of the first beam via the connection device, and wherein said first and second flanges extend in parallel alignment with each other on a first side of the first and second flanges when the second beam is connected to the first beam by means of the connection device.

According to one embodiment, the third flange has a surface that is in planar alignment with the first and second flanges on said first side of the first and second flanges.

According to one embodiment, the box arrangement comprises a screw joint via which the fourth flange is connected to the first beam.

According to one embodiment, the box arrangement comprises a plurality of first and second beams that are connected to each other by means of a connection device as defined hereinabove or hereinafter and that together define a box framework having openings defined by said first, second and third flanges, wherein the box arrangement comprises windows or wall elements that are arranged in said openings and that are sealingly bearing on said first, second and third flanges.

According to one embodiment, the first beam is a metal beam, the second beam is a metal beam, and the connection device is made of a material that is softer than the metal beam. Thereby, the connection device may be more easily deformed than the metal beams in order to form a sealing body between the beams that prevents leakage of air or gas into or out of the box defined by the box arrangement as the latter is provided with windows or wall elements in the openings defined by first beams and second beams that are interconnected by connection devices as defined hereinabove or hereinafter.

Further features and advantages of the present invention will be presented in the following detailed description of embodiments

### BRIEF DESCRIPTION OF THE DRAWINGS

Embodiments of the present invention will be presented more in detail and by way of example in the following detailed description with reference to the annexed drawing, on which,

FIG. 1 is a perspective view showing a first connection part connected to a first beam and a second connection part connected to a second beam in a starting position before joining of the first and second connections parts through a linear motion of one of the beams,

FIG. 2 is a perspective view showing the parts shown in FIG. 1 after joining of the first and second connection parts,

FIG. 3 is a cross section through the parts shown in FIG. 2,

FIG. 4 is a perspective view of a first connection part of a connection device according to the invention, as seen in a first direction,

FIG. 5 is the first connection part shown in FIG. 4 seen from a second direction,

FIG. 6 is the first connection part shown in FIG. 4 seen from a third direction,

FIG. 7 is a view from above of the first connection part shown in FIGS. 4-6,

FIG. 8 is a perspective view of a second connection part of a connection device according to the invention, as seen in a first direction,

FIG. 9 is the second connection part shown in FIG. 8 seen from a second direction,

FIG. 10 is the second connection part shown in FIG. 8 seen from third direction,

FIG. 11 is a view from below of the second connection part shown in FIGS. 8-10,

FIG. 12 is a perspective view showing the first connection part shown in FIGS. 4-7 connected to a first beam,

FIG. 13 is a cross section according to I-I in FIG. 12,

FIG. 14 is a perspective view shown the second connection part shown in FIGS. 8-11 connected to a second beam,

FIG. 15 is a cross section through the second connection part and second beam shown in FIG. 14, and

FIG. 16 is a perspective view of a box arrangement according to one embodiment of the invention.

### DETAILED DESCRIPTION

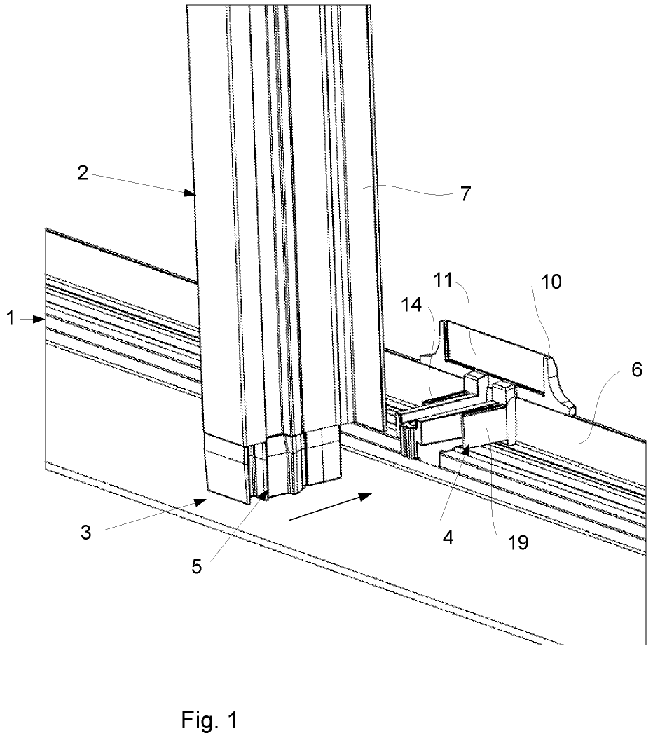

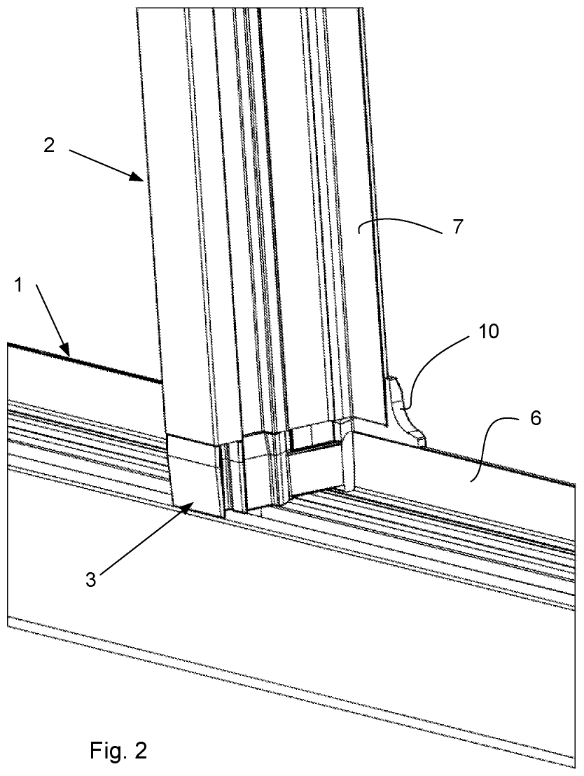

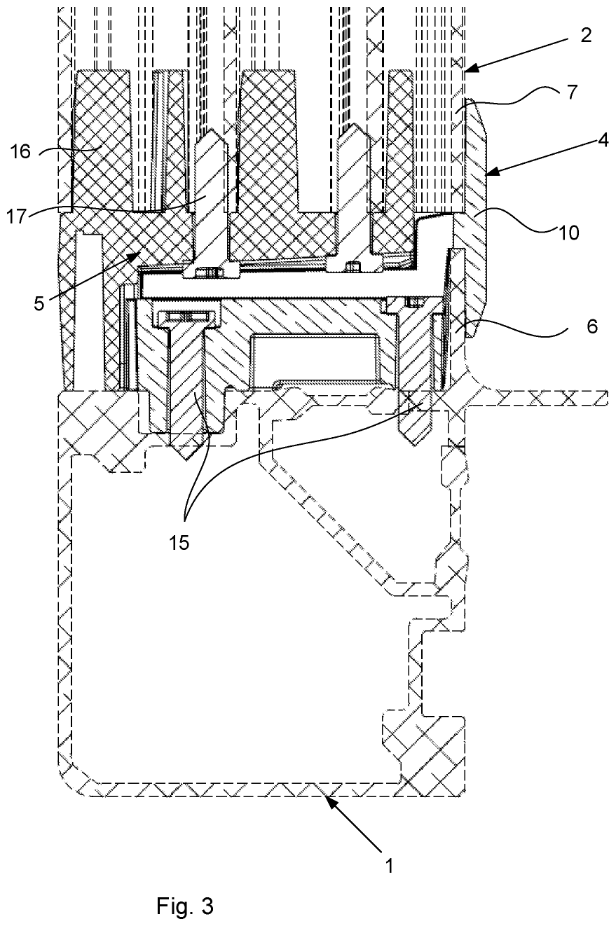

Reference is first made to FIGS. 1-3 which show part of a box arrangement before (FIG. 1) and after (FIGS. 2 and 3) joining of a first beam 1 to a second beam 2 by means of ac connection device 3. The connection device 3 comprises a first connection part 4 adapted to be connected to the first beam 1 and a second connection part 5 adapted to be connected to the second beam 2. The first beam 1 comprises a first flange 6 and the second beam 2 comprises a second flange 7.

The second beam 2 extends in a direction generally perpendicular to the first beam 1 when being connected thereto by means of the connection device 3 and is connected at a first one of its ends to a first side of the first beam 1 via the connection device 3. The first and second flanges 6, 7 extend in parallel alignment with each other on a first side 8 of the first and second flanges 6, 7 when the second beam 2 is connected to the first beam 1 by means of the connection device 3.

In the exemplifying embodiment, the first and second beams 1, 2 are profiled tubes made of a metal alloy, preferably an aluminium alloy, and at least one of the first connection part 4 and the second connection part 5 of the connection device 3 is made of polymer.

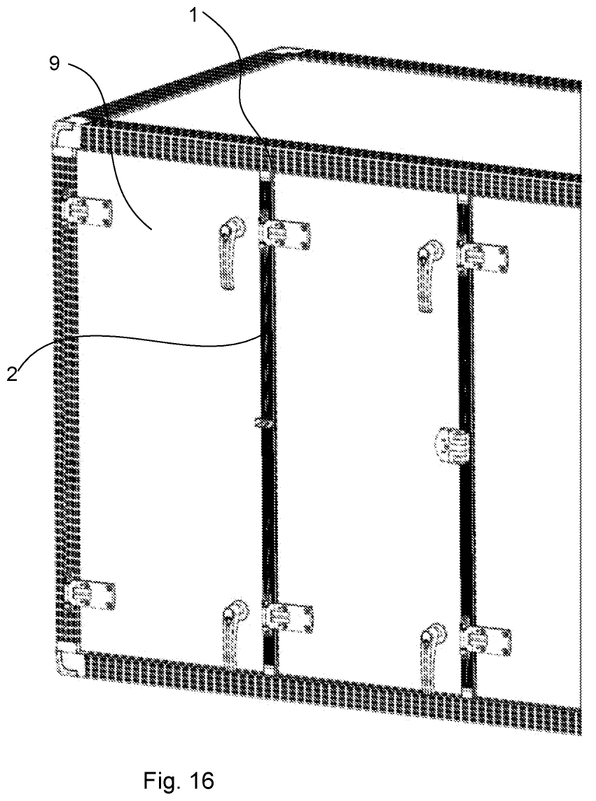

According to one embodiment, shown in FIG. 16, the box arrangement comprises a plurality of first and second beams 1, 2 that are connected by means of connection devices like the connection device 3 described hereinabove and hereinafter. The beams 6, 7 thereby define a plurality of openings in the box arrangement. On said first side 8 of the first and second flanges 6, 7, the first and second flanges 6, 7 define support surfaces for a window, a window frame, a door or a wall element or the like that is mounted in such an opening in the box arrangement. This is exemplified by doors 9 shown in FIG. 16. Preferably, there is provided a sealing element, not shown, between the window, door, wall element etc. and the first and second flanges 6, 7.

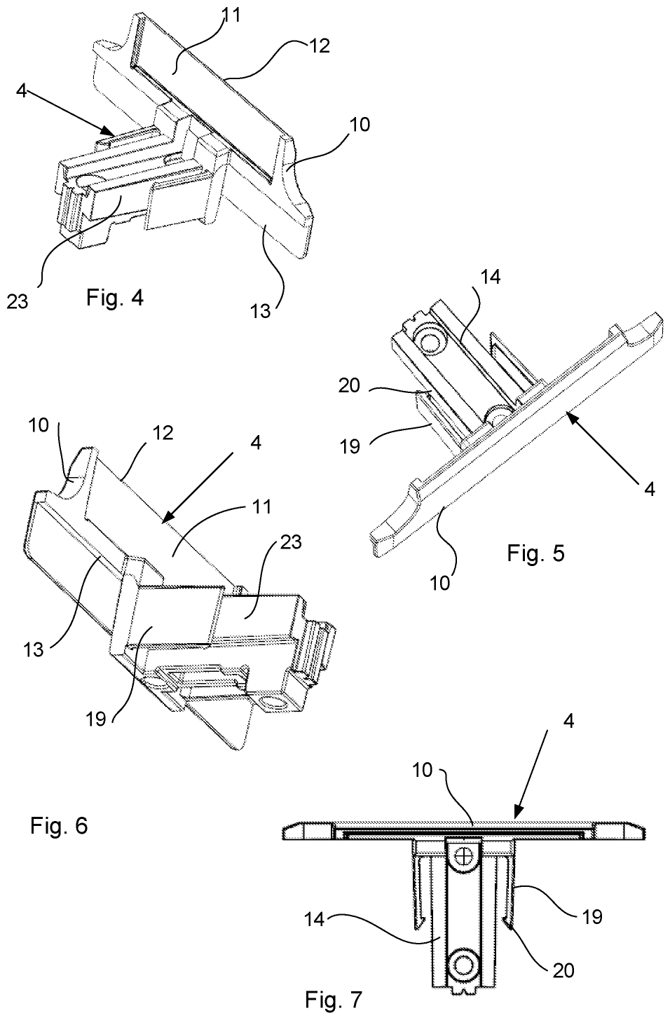

The first part 4 of the connection device 3 comprises a third flange 10 that forms a sealing between the first flange 6 and the second flange 7. The third flange 10 is in parallel alignment with the first flange 6 and the second flange 7 on said first side 8 of the first and second flange 6, 7 when being connected to the first beam 1. Reference is also made to FIGS. 4-7, which show the first connection part 4 more in detail from different angles. The third flange 10 comprises a recess 11 that accommodates the second flange 7 when the second beam 2 is connected to the first beam 1 via the connection device 3. The recess 11 extend from a first end 12 of the third flange 10 towards a second end 13 of the third flange 10 that bears on a free end of the first flange 6 when the second beam 2 is connected to the first beam 1 via the connection device 3.

The recess 11 has a depth corresponding to the thickness of the second flange 7. The recess 11 ends at a predetermined distance from the second end 13 of the third flange, so that there is a small rim of material defined by the third flange 10 between the first flange 6 and the second flange 7. The width of the recess 11 corresponds to the width of the second flange 7. If there is provided a sealing between a window, door, wall element etc. and the first and second flanges 6, 7, such sealing may extend over and cover said rim comprised by the third flange 10 between the first flange 6 and the second flange 7 in order to provide for improved total sealing.

On the side of the first flange 1 opposite to said first side 8 thereof, the third flange 10 has a portion that overlaps the first flange 6, such that both stability of the third flange 10 and sealing function thereof is improved.

The first connection part 4 further comprises a fourth flange 14 that extends perpendicularly to the third flange 10, which fourth flange 14 is configured to bear on said first side of the first beam and which fourth flange 14 is configured to be connected to the first beam. A screw joint 15 connects the fourth flange 14 with the first side of the first beam 1. The position of the first connection part 4 along the first beam 1 can thus easily be adapted to the specific box design that is requested. Holes for the screw may be bored in the first beam 1, or be formed by the screw provided that the latter is of a self-driving kind that generates a hole in the first beam 1 as it is driven into the latter.

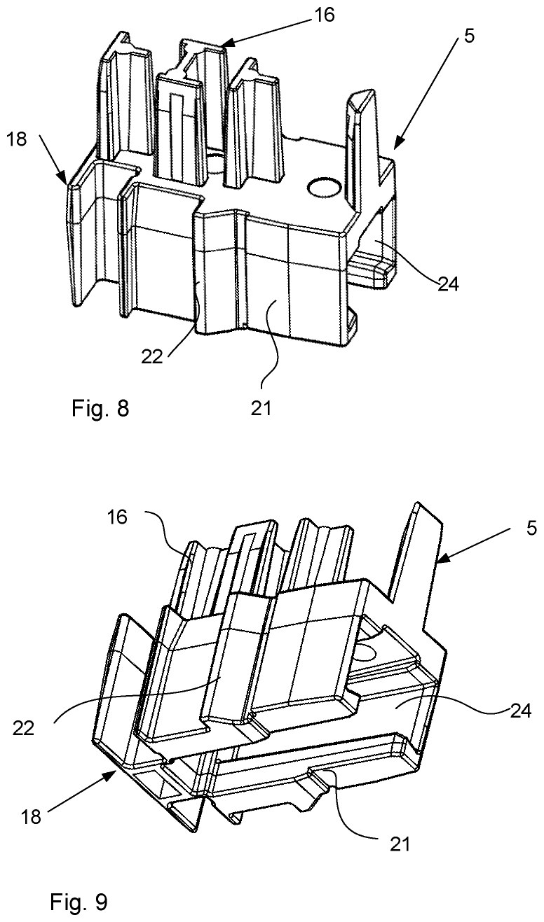

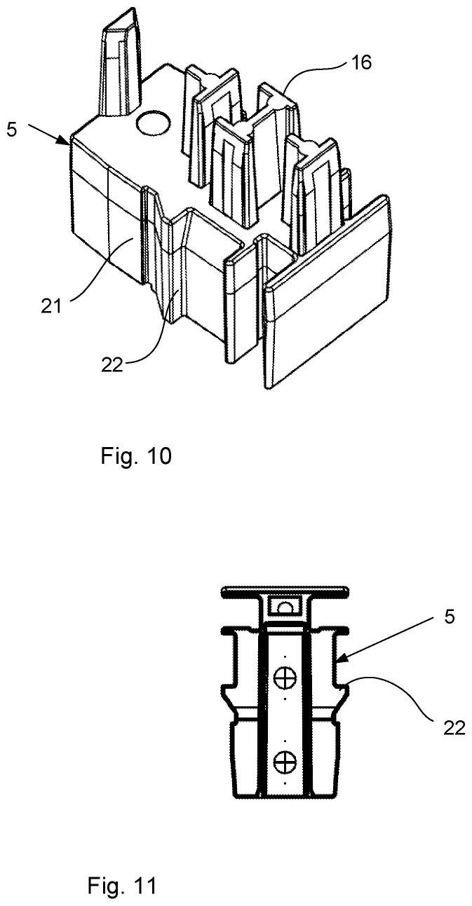

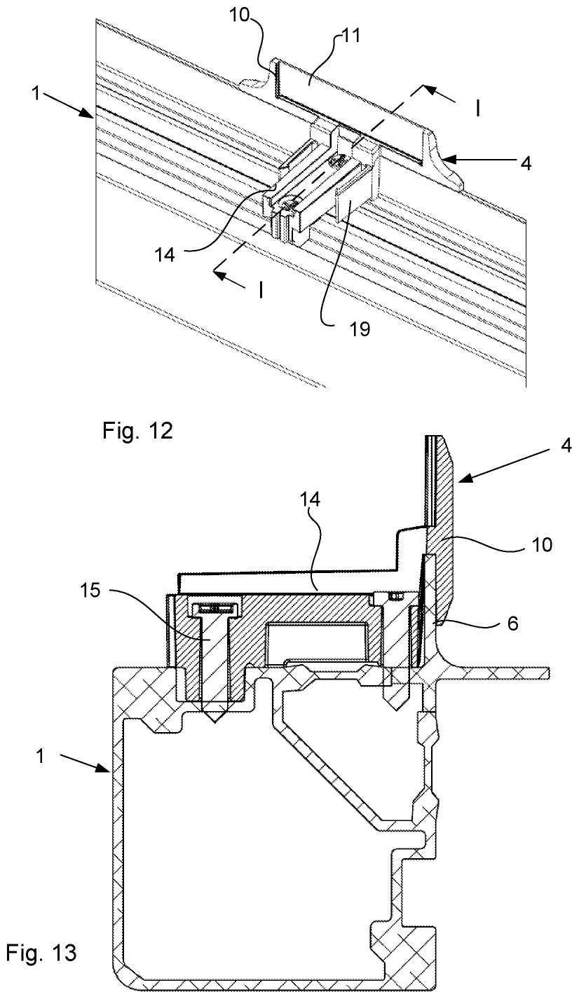

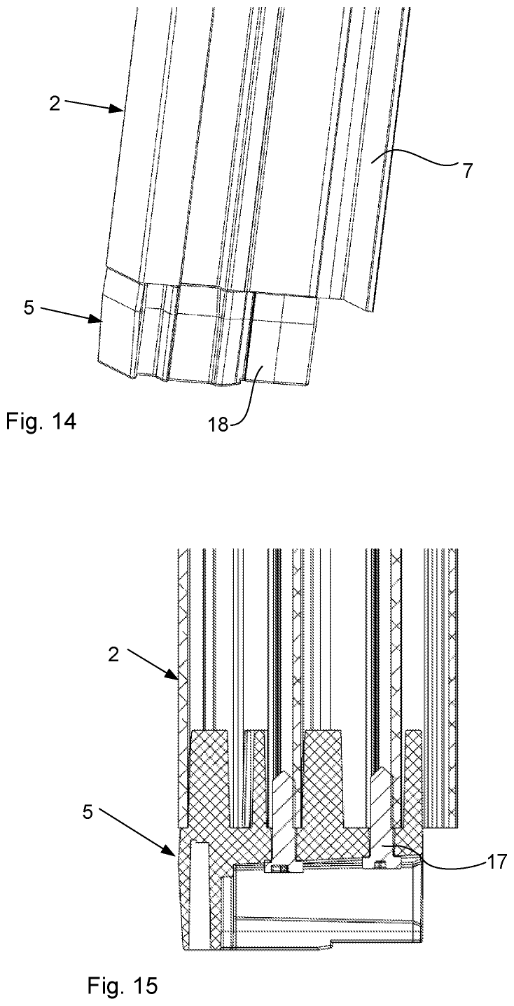

FIGS. 8-11 show the second connection part 5 from different angles. The second connection part 5 is configured to be, and is, attached to an end of the second beam 2. The second beam 2 has tubular and irregular, non-circular, cross-section and the second connection part 5 is provided with a first portion 16 that project into the open end of the second beam 2 and engages the latter in a form-locking manner that prevents rotation of the second connection part 5 relative to the second beam 2. There is also provided a screw joint 17 between the second connection part 5 and the second beam 2 that prevents linear motion of the second connection part 5 relative to the second beam 2 in the longitudinal direction of the latter.

The second connection part 5 also comprises a second portion 18 aimed to be connected to the first connection part 4. For that purpose, the first connection part 4 and the second connection part 5 of the connection device 3 comprise a snap device for snap engagement with each other. The snap device comprises resilient members 19, here provided on the first connection part 4, that carries a first engagement means 20 formed by heels. A receiving member 21, for receiving said resilient members 19 and the first engagement means, is arranged on the second part 5 of the connection device 3, wherein the receiving member 21 carries second engagement means 22 for engagement with said first engagement means 20.

The second engagement means 22 is formed by an abutment member arranged on an outer periphery of the second portion 18 of the second connection part 5. The resilient members 19 are formed be two arms extending from the third flange 10 on opposite sides of the fourth flange 14. The receiving member 21 has a hollow interior into which the fourth flange 14 projects such that the fourth flange 14 engages with the receiving member 21 and thereby stabilizes the connection of the second connection part 5 to the first connection part 4.

The first connection part 4 is thus configured to be connected to the second connected part 5 through a linear displacement of the second beam 2 in a direction perpendicular to the longitudinal directions of the first beam 1 and the second beam 2 such that the first and second connection parts 4, 5 will be joined by snap engagement. Reference is made to FIGS. 1 and 2.

The first connection part 4 comprises guide surfaces 23 and the second connection part 5 comprises corresponding guide surfaces 24 for guiding the first connection part 4 and second connection part 5 into snapping engagement through the snap device through a displacement of the second part in a direction perpendicular to the longitudinal directions of the first beam 1 and the second beam 2. The guide surfaces 23 on the first connection part are formed by surfaces on the outer periphery of the fourth flange 14. The guide surfaces 24 on the second connection part 5 are formed by surfaces on an inner periphery of the receiving member 21. The guiding fourth flange 14 thereby fits into the receiving member 21 in such a manner (shape-locking) that it prevents motion of the second connection part 5 in the longitudinal direction of the second beam 2 in relation to the first connection part 4 and also in the longitudinal direction of the first beam 1.

1. A connection device for a box-arrangement, the connection device comprising:
a first connection part adapted to be connected to a first beam comprising a first flange; and
a second connection part adapted to be connected to a second beam comprising a second flange,
wherein the second beam is configured to extend in a direction generally perpendicular to the first beam when being connected thereto by means of the connection device and is configured to be connected at a first one of its ends to a first side of the first beam, and wherein the first and second flanges are configured to extend in parallel alignment with each other on a first side of the first and second flanges when the second beam is connected to the first beam by means of the connection device,
the connection device is adapted for connecting the first end of the second beam to the first side of the first beam,
the first connection part comprises a third flange which is configured to extend in parallel alignment with the first flange of the first beam on the first side of the first flange and to bear on the first flange when the first connection part is connected to the first beam and which third flange comprises a recess configured for receiving the second flange of the second beam when the second beam is connected to the first beam by means of the connection device,
the second connection part is adapted to be connected to the first end of the second beam, and
the first connection part and the second connection part of the connection device comprise a device for engagement with each other.

2. The connection device according to claim 1, wherein the device for engagement of the first connection part with the second connection part comprises a snap device for snap engagement.

3. The connection device according to claim 2, wherein the snap device comprises a resilient member that carries a first engagement means and is arranged on one of the first part or second part of the connection device, and a receiving member arranged on the other of the first part and the second part of the connection device, and wherein the receiving member carries a second engagement means for engagement with the first engagement means.

4. The connection device according to claim 3, wherein the first engagement means comprises a first abutment member and the second engagement means comprises a second abutment member.

5. The connection device according to claim 2, wherein the first connection part and the second connection part comprise guide surfaces for guiding the first part and second part into snapping engagement through the snap device through a displacement of the second part in a direction perpendicular to the longitudinal directions of the first beam and the second beam, wherein the first connection part is connected to the first beam and the second connection part is connected to the second beam during the displacement.

6. The connection device according to claim 1, wherein the recess has a depth corresponding to the thickness of the second flange.

7. The connection device according to claim 1, wherein the recess extends from a first free end of the third flange towards a second end of the third flange, which second end is adapted to bear on an end part of the first flange when the first connection part is connected to the first beam, and the recess ends at a predetermined distance from the second end of the third flange.

8. A box arrangement including the connection device according to claim 1, wherein the first part of the connection device has a fourth flange that extends perpendicularly to the third flange, which fourth flange is configured to bear on the first side of the first beam and which fourth flange is configured to be connected to the first beam.

9. A box arrangement comprising:
a first beam comprising a first flange and a second beam comprising a second flange,
wherein the first beam is connected to the second beam by means of a connection device according to claim 1,
wherein the second beam extends in a direction generally perpendicular to the first beam when being connected thereto by means of the connection device and is connected at a first one of its ends to a first side of the first beam via the connection device, and
wherein the first and second flanges extend in parallel alignment with each other on a first side of the first and second flanges when the second beam is connected to the first beam by means of the connection device.

10. A box arrangement according to claim 9, wherein the third flange has a surface that is in planar alignment with the first and second flanges on the first side of the first and second flanges.

11. A box arrangement according to claim 10, further comprising a screw joint via which the fourth flange is configured to be connected to the first beam.

12. A box arrangement according to claim 9, further comprising a plurality of first and second beams that are connected to each other by means of the connection device and that together define a box framework having openings defined by the first, second and third flanges, and the box arrangement comprises windows, doors or wall elements that are arranged in the openings and that are sealingly bearing on the first, second and third flanges.

13. A box arrangement according to claim 9, wherein the first beam is a metal beam, the second beam is a metal beam, and the connection device is made of a material that is softer than the metal beam.
